(19) United States
(12) Patent Application Publication
(10) Pub. No.: US 2004/0158572 A1
(43) Pub. Date: Aug. 12, 2004

(54) Database and database management system

(75) Inventors: Victor A. Bennett, Rockwall, TX (US); Gregory E. Geiger, Plano, TX (US); Gerald R. Platz, Heath, TX (US); Sean M. Bennett, Heath, TX (US); Aya N. Bennett, Heath, TX (US); Michael B. Early, Plano, TX (US); Randall A. Simpson, Garland, TX (US); Frederick R. Petersen, Dallas, TX (US); Kenneth Lee Mahrt, Heath, TX (US); Zhixuan Zhu, Dallas, TX (US)

Correspondence Address: Craig J. Cox, CALPONT CORPORATION, 635 Cullins Road, Rockwall, TX, 75032, US

(73) Assignee: Calpont Corporation, Rockwall, TX (US)

(21) Appl. No.: 10/712,644

(22) Filed: Nov. 13, 2003

Related U.S. Application Data
(60) Provisional application No. 60/426,711, filed on Nov. 15, 2002.

(51) Int. Cl. G06F 17/00

(52) U.S. Cl. 707/101

(57) ABSTRACT

A database and database management system are implemented entirely in hardware. The information forming the database is stored in random access memory which is connected to a data flow engine. The data flow engine is able to process statements in standard database protocols such as SQL and XML, and to manipulate (read, write and alter) the database in accordance with the statements. The data flow engine is connected to a microprocessor that receives the statements from the database user or database application server and sends them to the data flow engine for processing. The results from the data flow engine are returned to the microprocessor and the microprocessor then returns the results to the user or application server.

### CROSS-REFERENCE TO RELATED APPLICATION

This application claims priority of Provisional Application Serial No. 60/426,711 which was filed Nov. 15, 2002.

### TECHNICAL FIELD OF THE INVENTION

The present invention relates to database structures and database management systems. Specifically, the present invention relates to a protocol independent database structure and a hardware implementation of a protocol independent database management system.

### BACKGROUND OF THE INVENTION

The term database has been used in an almost infinite number of ways. The most common meaning of the term, however, is a collection of data stored in an organized fashion. Databases have been one of the fundamental applications of computers since they were introduced as a business tool. Databases exist in a variety of formats including hierarchical, relational, and object oriented. The most well known of these are clearly the relational databases, such as those sold by Oracle, IBM and Microsoft. Relational databases were first introduced in 1970 and have evolved since then. The relational model represents data in the form of two-dimensional tables, each table representing some particular piece of the information stored. A relational database is, in the logical view, a collection of two-dimensional tables or arrays.

Though the relational database is the typical database in use today, an object oriented database format, XML, is gaining favor because of its applicability to network, or web, services and information. Objected oriented databases are organized in tree structures instead of the flat arrays used in relational database structures. Databases themselves are only a collection of information organized and stored in a particular format, such as relational or object oriented. In order to retrieve and use the information in the database, a database management system (“DBMS”) is required to manipulate the database.

Traditional databases suffer from some inherent flaws. Although continuing improvements in server hardware and processor power can work to improve database performance, as a general rule databases are still slow. The speeds of the databases are limited by general purpose processors running large and complex programs, and the access times to the disk arrays. Additionally, significant time and money must be spent to continually optimize the disk arrays to keep their performance from degrading as data becomes fragmented.

Additionally, database management systems are very expensive to acquire and maintain. The primary cost associated with database management systems are initial and recurring licensing costs for the database management programs and applications. The companies licensing the database software have constructed a cost structure that charges yearly license fees for each processor in every application and DBMS server running the software. So while the DBMS is very scalable the cost of maintaining the database also increased proportionally. Also, because of the nature of the current database management systems, once a customer has chosen a database vendor, the customer is for all practical purposes tied to that vendor. Because of the extreme cost in both time, expense and risk to the data, changing database programs is very difficult, this is what allows the database vendors to charge the very large yearly licensing fees that currently standard practice for the industry.

The next major problem is the reason that changing databases is such an expensive problem. While all major database programs being sold today are relational database products based on a standard called Standard Query Language, or SQL, each of the database vendors has implemented the standard slightly differently resulting, for all practical purposes, in incompatible products. Also, because the data is stored in relational tables in order to accommodate new standards and technology such as Extensible Mark-up Language (“XML”) which is not relational, large and slow software programs must be used to translate the XML into a form understandable by the relational products, or a completely separate database management system must be created, deployed and maintained for the new XML database.

Accordingly, what is needed is a database management system with improved performance over traditional databases and which is protocol agnostic.

### SUMMARY OF THE INVENTION

The present invention provides for a database management engine implemented entirely in hardware. The database itself is stored in random access memory (“RAM”) and is accessed using a special purpose processor referred to as the data flow engine. The data flow engine parses standard SQL and XML database commands and operations into machine instructions that are executable by the data flow engine. These instructions allow the data flow engine to store, retrieve, change and delete data in the database. The data flow engine is part of an engine card which also contains a microprocessor that performs processing functions for the data flow engine and converts incoming data into statements formatted for the data flow engine. The engine card is connected to a host processor which manages the user interfaces to the data base management engine.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art will appreciate that they can readily use the disclosed conception and specific embodiment as a basis for designing or modifying other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a prior art database topology diagram;

FIG. 2 illustrates a database topology constructed according to the principles of the present invention, including a block diagram of a database management engine in accordance with the principles of the present invention;

FIG. 3 illustrates an alternative database topology constructed according to the principles of the present invention;

FIG. 4 illustrates a block diagram of an embodiment of the database management engine from FIG. 3;

FIG. 5 illustrates a block diagram of an embodiment of a data flow engine from FIG. 4; and

FIG. 6 illustrates a block diagram of an embodiment of a database management engine, according to the present invention, which is compatible with a compact PCI form factor.

### DETAILED DESCRIPTION OF THE DRAWINGS

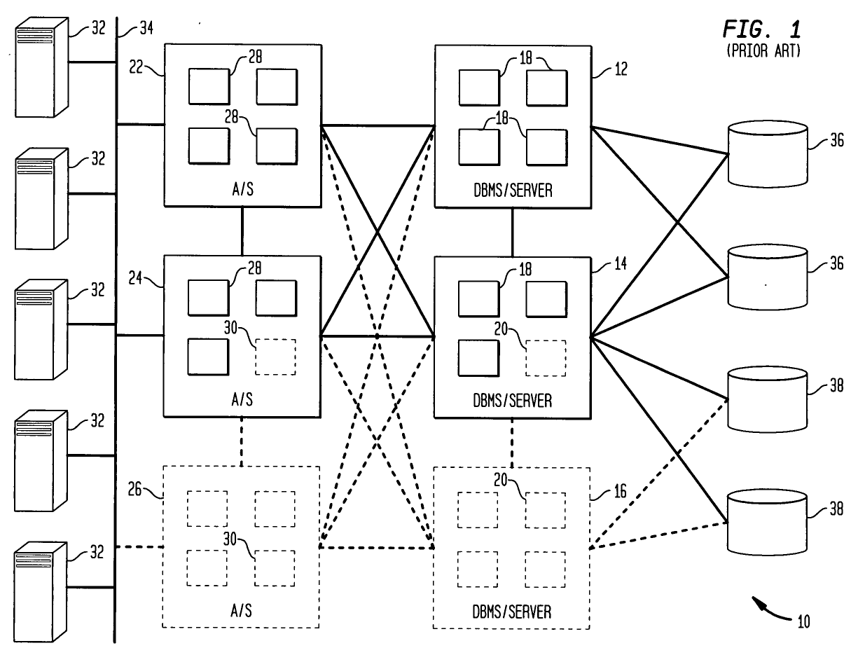

Referring now to FIG. 1, a diagram of a prior art networked database management system 10 is shown. The prior art database management system (“DBMS”) is implemented using general purpose DBMS servers 12 and 14, such as those made by Sun, IBM, and Dell, running database programs such as Oracle, DB2, and SQL Server. The programs run on one or more general purpose microprocessors 18 in the DBMS servers 12 and 14. The data in the database is stored using arrays of disk drives 36 and 38. Small portions of the overall database can be cached in the servers 12 and 14 to aid performance of database management system 10 since the access time to read and write to disk arrays 36 and 38 can slow performance considerably.

In addition to the DBMS servers 12 and 14 the database management system 10 can include application servers 22 and 24 that run in conjunction with the DBMS servers 12 and 14. While the DBMS servers manage the essential database functions such as storing, retrieving, changing, and deleting the data contained in disk arrays 36 and 38, the application servers run programs that work with the DBMS to perform tasks such as data mining, pattern finding, trend analysis and the like. The application servers 22 and 24 are also general purpose servers with general purpose microprocessors 28 running the application programs.

The database management system 10 is accessed over network 34 by workstations 32 which represent the users of the database. The users send instructions to the application servers which then access the DBMS servers to get the appropriate response for the users. Because the database management system 10 is accessed via a network the users and the database, and even the individual elements of the database do not have to be co-located.

One of the advantages of database management system 10 is its scalability. The database, database management system, and application servers can be easily scaled in response to an increase number of users, increased data in the database itself or more intensive applications running on the system. The system may be scaled by adding processors such has processors 10 and 30 to the existing application servers, and DBMS servers, or additional application servers and DBMS servers 26 and 16, respectively, can be added to handle any increased loads. Additionally, new disk arrays can be added to allow for an increase in the size of the actual database, or databases, being stored.

While database management system 10 can work with very large databases and can scale easily to meet differing user requirements, it does suffer from a multitude of well know problems. Although continuing improvements in server hardware and processor power can work to improve database performance, as a general rule databases, such as those constructed as described with respect to database management system 10 are still slow. The speeds of the databases are limited by general purpose processors running large and complex programs, and the access times to the disk arrays, such as disk arrays 36 and 38. Additionally, significant time and money must be spent to continually optimize the disk arrays to keep their performance from degrading as data becomes fragmented.

Additionally, database management system 10 is very expensive to acquire and maintain. The primary cost associated with database management system 10 is initial and recurring licensing costs for the database management programs and applications. The companies licensing the database software have constructed a cost structure that charges yearly license fees for each processor in every application and DBMS server running the software. So while the DBMS is very scalable the cost of maintaining the database also increased proportionally. Also, because of the nature of the current database management systems, once a customer has chosen a database vendor, the customer is for all practical purposes tied to that vendor. Because of the extreme cost in both time, expense and risk to the data, changing database programs is very difficult, this is what allows the database vendors to charge the very large yearly licensing fees that currently standard practice for the industry.

The next major problem is the reason that changing databases is such an expensive problem. While all major database programs being sold today are relational database products based on a standard called Standard Query Language, or SQL, each of the database vendors has implemented the standard slightly differently resulting, for all practical purposes, in incompatible products. Also, because the data is stored in relational tables in order to accommodate new standards and technology such as Extensible Mark-up Language (“XML”) which is not relational, large and slow software programs must be used to translate the XML into a form understandable by the relational products, or a completely separate database management system must be created, deployed and maintained for the new XML database.

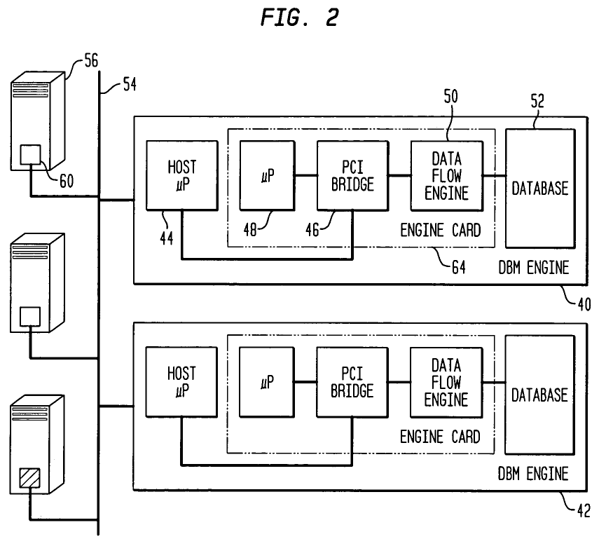

Referring now to FIG. 2, a database management system that addresses the deficiencies of the database management system in FIG. 1 is described. Database management (“DBM”) engine 40 replaces database management system 10 from FIG. 1. DBM engine 40 is a complete database management system implemented in special purpose hardware. By implementing the database management system entirely in hardware, DBM engine 40 overcomes may of the problems traditionally associated with database management systems. Not only is the database management aspect implemented in hardware, but the database, shown here as database 52, itself is stored in random access memory (“RAM”) allowing for very fast storage, retrieval, alteration and deletion of the data itself. Further, DBM engine 40 stores information in database 52 in a unique data structure that is protocol agnostic, meaning that DBM engine 40 is able to implement both SQL and XML databases in hardware using the same unique data structure in database 52.

DBM engine 40 can be configured to communicate with workstation 56 over network 54. A software program and/or driver 60 is installed on workstation 60 to manage communication with DBM engine 40 and possibly to perform some processing on the information exchanged between workstation 56 and DBM engine 40. DBM engine 40 is designed to be transparent to the user using workstation 56. In other words, the user, whether they have been trained on Oracle, IBM DB2, Microsoft SQL Server, or some other database, will be able to access DBM engine 40 and database 52 using substantially the same form of SQL or XML that are already familiar with. This allows existing databases to be transitioned to DBM engine 40 with only minimal training of existing users.

DBM engine 40 is comprised of engine card 64, host microprocessor 44 and database 52. Connections with DBM engine 40 are verified by host microprocessor 44. Host microprocessor 44 establishes connections with workstations 56 using standard network database protocols such as ODBC, or JDBC. Host microprocessor 44, in addition to managing access, requests and responses to DBM engine 40, can also be used to run applications, perform some initial processing on queries to the database and other processing overhead that does not need to be performed by engine card 64.

Engine card 64 is a hardware implementation of a database management system such as those implemented in software programs by Oracle, IBM and Microsoft. Engine card 64 includes a PCI bridge 46 which is used to communicate with host microprocessor 44, and to pass information between microprocessor 48 and data flow engine 50. Microprocessor 48 places the requests from host microprocessor 44 into the proper format for data flow engine 50, queues requests for the data flow engine, and handles processing tasks that cannot be performed by data flow engine. Microprocessor 48 communicates with data flow engine 50 through PCI bridge 46, and all information in and out of data flow engine 50 pass through microprocessor 48.

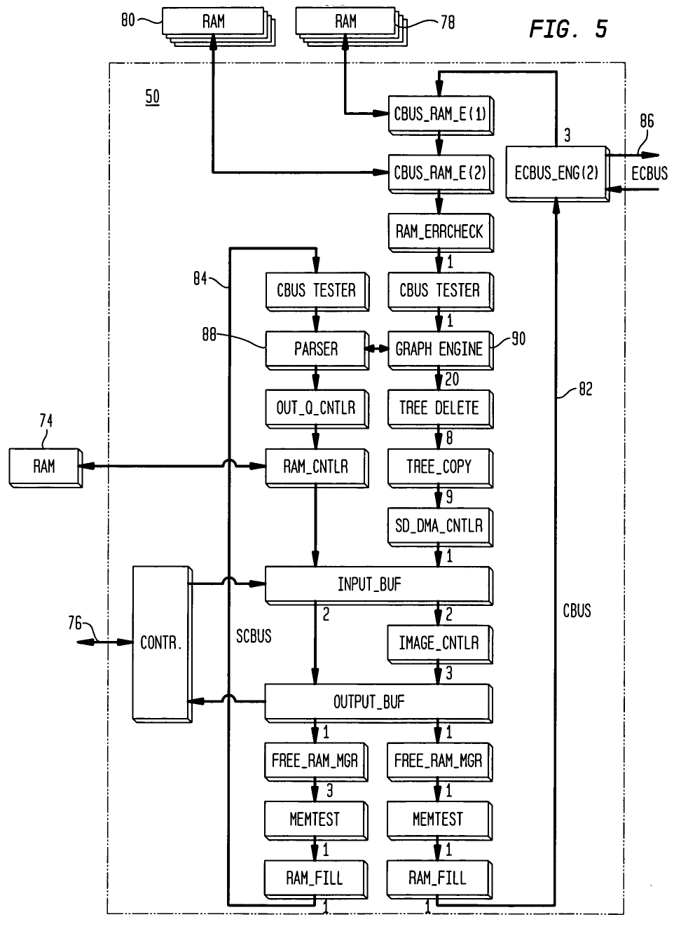

Data flow engine, which is described in greater detail with reference to FIG. 5, is a special purpose processor optimized to process database functions. Data flow engine can be implemented as either a field programmable gate array (“FPGA”) or as an application specific integrated circuit (“ASIC”). Data flow engine 52 is the interface with database 52. Data flow engine is responsible for storing, retrieving, changing and deleting information in database 52. Because all of the database functionality is implemented directly in hardware in data flow engine 52, there is no need for the software database management programs. This eliminates initial and recurring license fees currently associated with database management systems.

Also, because the database management system is all in hardware and because database 52 is stored entirely in RAM, the time required to process a request in the database is significantly faster than in current database management systems. With current database management systems requests must pass back and forth between the various levels of software, such as the program itself and the operating system, as well as several levels of hardware, which include the processor local RAM, input/output processors, external disk arrays and the like. Because requests must pass back and forth between these various software levels and hardware devices, responses from the database management system to requests is very time consuming and resource intensive. DBM 40 engine, on the other hand, passes requests straight to the data flow engine 50, which then access memory directly, processes the response and returns the response, all at machine level without have to pass through an operating system and software program and without having to access and wait on disk arrays. The approach of the present invention is orders of magnitude faster than current implementations of database management systems.

DBM engine 40 is also readily scalable, as with current database management systems. In order to accommodate more users or larger databases the RAM associated with database 52 can be increased, and/or additional DBM engines, such as DBM engine 42, can be added to the network. Being able to scale the database management system of the current invention, by sampling adding additional memory or DBM engines allows a user to only purchase the system required for their current needs. As those needs change, additional equipment can be purchased to keep pace with growing requirements. Without the requirement of the database management programs and additional processors, as discussed with reference to FIG. 1, scaling a database management system in accordance with the present invention would never require additional software licenses and fees.

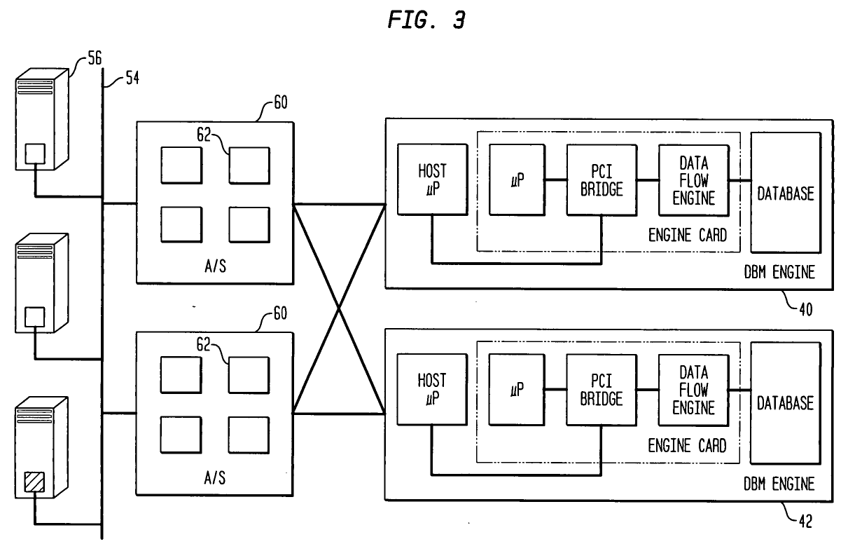

Referring now to FIG. 3, a database management system according to the present invention is shown which incorporates existing application servers 60 with processors 62 to perform more complex applications, such as data mining, pattern identification and trend analysis. DBM engines 40 and 42 still provide the database and the database management function, but application servers 60 have been added to allow for complex applications to be run without consuming the resources of DBM engines 40 and 42. Additionally, existing database hardware can be used as application servers in the database management system of the present invention so that existing resources are not wasted when an existing database is converted to the database management system of the present invention. As with the database management system shown in FIG. 1, the users, represented by workstation 56, communicate over network 54 with applications servers 60. Application servers 60 then access the resources of DBM engines 40 and 42 and pass the responses back to workstations 56.

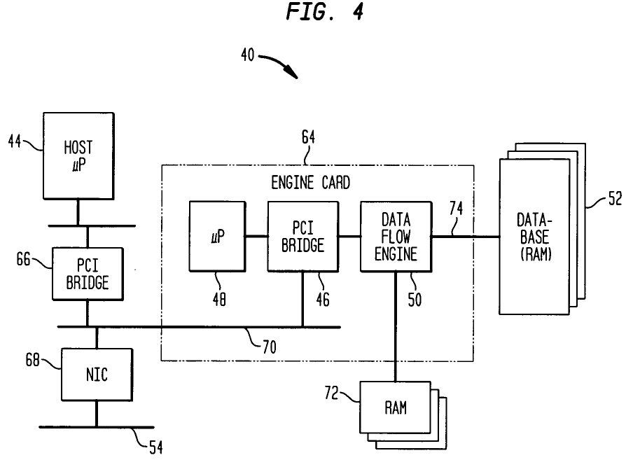

Referring now to FIG. 4, the DBM engine 40 is shown in greater detail. DBM engine 40 is in communication with network 54 through network interface card (“NIC”) 68. NIC 68 is then connected to PCI bus 70. Requests to and responses from DBM engine 40 are passed by NIC 68 through host PCI bridge 66 to host microprocessor 44. As stated with respect to FIG. 2, host microprocessor 44 is used to track and authenticate users, pass requests and responses using standard database communication drivers, multiplex and demultiplex requests and responses, and to help format requests and responses for processing by data flow engine 50. Host microprocessor 44 communicates with microprocessor 48 on engine card 64 through PCI bridge 46. Host microprocessor sends multiplexed data to microprocessor 48 is blocks. Blocks in the current embodiment are 64 kbytes long.

Microprocessor 48 receives the requests from host microprocessor 44 and passes data flow engine the requests in the form of a statement that in the current embodiment of the present invention is 32 characters long. Data processing engine 50 takes the statements from microprocessor 48 and performs the requested functions on the database. The operation of data flow engine 50 will be discussed in greater detail with reference to FIG. 5. Data flow engine 50 accesses database 52 using bus 74.

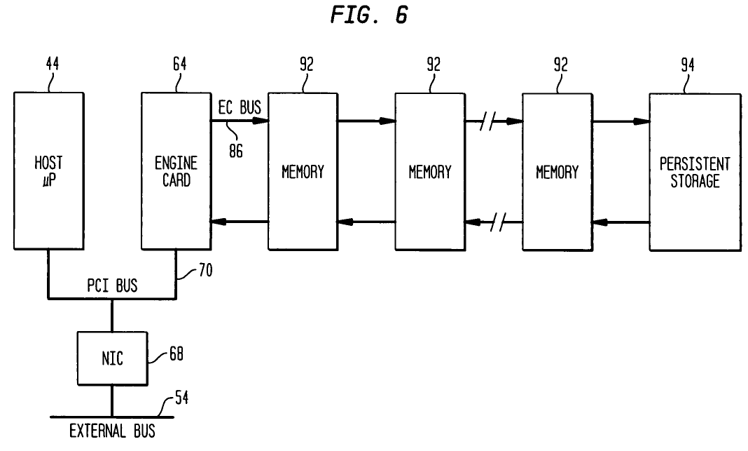

As stated, database 52 is stored in RAM instead of on disk arrays as with traditional databases. This allows for much quicker access times than with a traditional database. Also, as stated the data in database 52 is protocol independent. This allows DBM engine 40 to store object oriented, or hierarchical information in the same database as relational data. As opposed to storing data in the table format used by the relational databases, data flow engine 50 stores data in database 52 in a tree structure where each entry in the tree stores information about the subsequent entries in the tree. The tree structure of the database provides a means for storing the data efficiently so that much more information can be stored than would be contained in a comparable disk array using a relation model. For more information about databases using tree structures see U.S. Pat. No. 6,185,554 to Bennett, which is hereby incorporated by reference. Database 52 can contain multiple banks of RAM and that RAM can be co-located with data flow engine 50 or can be distributed on an external bus, as will be shown in FIG. 6.

In addition to database 52, data flow engine is connected to working memory 72. Working memory 72 is also RAM memory, and is used to store information such as pointers, status, and other information that is used by data flow engine 50 when traversing the database.

Referring now to FIG. 5, data flow engine 50 is discussed in greater detail. Data flow engine 50 is responsible for receiving actions to be taken with respect to the database, carrying out those actions, and returning results as appropriate. Data flow engine 50 is able to store, change, retrieve, update and delete all of the data stored in database 52 from FIG. 4. Data flow engine is comprised primarily of two major components: the parser 88 and the graph engine 90. The parser 88 takes the statements received from microprocessor 48 of FIG. 4 and separates the command words and operators in SQL or XML, from the variables. The command words and operators are then translated into fixed length instructions understandably by the graph engine 90. The graph engine 90 is responsible for reading from and writing to the trees stored in RAM. The graph engine 90 takes the instructions and variable data received from the parser 88 and executes the instructions with the variable data to read from or write to the trees making up the database.

PCI bus 76 is the data bus connecting data flow engine 50 to microprocessor 48 from FIG. 4. Statements received from microprocessor 48 are processed by controller CONTR and then placed onto parser ring bus 84 via input buffer INPUT_BUF. The data on parser ring bus 84 arrives at the parser where it is separated into operators and commands and variables. The data my have to traverse parser ring bus more than once, such as when data must be stored in or retrieved from working memory 74 using memory controller RAM-CNTLR. Other blocks shown on parser ring bus 84 perform testing functions, such as memory tester MEMTEST and bus tester CBUS TESTER, or help manage working memory 74, as is the case with free memory manager FREE_RAM_MGR, and initialize block RAM_FIL which writes all of the working memory to a known state upon initialization. Once parser 88 has placed the data into the instructions and variables in a known format, the current embodiment of the present invention uses a 256 byte data format which includes a 64 byte header and 4×64 byte payload referred to as a cell, the parser passes the cell to the graph engine when the graph engine indicates that it has a free context to work on.

The graph engine 90 is a pipelined engine that can work on up to 64 contexts at once. The graph engine 90 takes the cell from the parser and executes any instructions contained therein. The instructions tell the graph engine 90 to either retrieve particular information from the tree, to write to the tree or to delete information from the tree. The graph engine 90 uses cell bus 82 to read and write to the trees. The trees are stored in RAM which can either be local RAM such as local memory 78 and 80, which is controlled by memory controllers CBUS_RAM_E1 or CBUS_RAM_E2, respectively, or can be external RAM which is reached by external cell bus 86. External cell bus controller ECBUS_ENG recognizes any external memory cards connected to data flow engine 50 and treats extended cell bus 86 as simply and extension of cell bus 82.

Other blocks on cell bus 82 perform similar test or utility functions as was described with reference to parser ring bus 84. Tree utility blocks TREE_DELETE and TREE_COPY operate to off load some routine tasks from graph engine 90. Tree utility TREE_DELETE is used to delete entire trees within the database while tree utility TREE_COPY is used to copy trees within the database which is used when a tree is being altered by a user, but has not been released general access to the rest of the database users. Test utility block MEMTEST is used to perform memory tests on the RAM. Free memory manager FREE_RAM_MGR is used to keep track of unused memory within the database.

Referring now to FIG. 6, an embodiment of the present invention implemented in accordance with the compact PCI architecture is described. The database management system works exactly as described with reference to FIGS. 2 through 5. The use of the compact PCI form factor allows additional memory cards to be connected on external cell bus 86. As many memory cards 92 may be connected to external cell bus 86 as are available in the compact PCI chassis. In addition to the memory cards 92, a persistent storage medium may be connected to the external cell bus 86 to allow a non-volatile version of the database to be maintained in parallel with the database stored in RAM. The persistent storage medium may be disk drives or may be a static device such as flash memory.

The microprocessors described with reference to FIGS. 2 through 4 could be any suitable microprocessor including the PowerPC line of microprocessors from Motorola, Inc., or the X86 or Pentium line of microprocessors available from Intel Corporation. Additionally, the PCI bridges and network interface cards are well know parts readily available. Although particular references have been made to specific protocols, implementations and materials, those skilled in the art should understand that the network processing system, the policy gateway can function independent of protocol, and in a variety of different implementations without departing from the scope of the invention in its broadest form.

We claim:

1. A hardware database for implementing known database protocols comprising:
a database stored in a memory;
a microprocessor operable to receive statements from a user, the statements in a known database protocol format, operable to manipulate data in the database; and
a data flow engine in communication with the microprocessor and the database and operable to receive the statements from the microprocessor and to process the statements against the database.

2. The hardware database of claim 1 wherein the dataflow engine further comprises:
a parser receiving the standardized database statements and converting the standardized database statements into executable instructions and data objects;
an execution tree processor connected to the parse and receiving the executable instructions from the parser, the execution tree processor creating execution trees from the executable instructions and schedules the execution trees for execution; and
a graph engine connected to the execution tree processor, the graph engine operable to manipulate the database as required by the executable instructions.

3. The hardware database of claim 1 wherein the information in the database is represented in memory in the form of graphs.

4. The hardware database of claim 1 wherein the hardware database is connected directly to a network using a network connection, and the microprocessor is operable to receive the statements from the users over the network connection.

5. The hardware database of claim 1 wherein the hardware database is connected to application servers, the applications servers providing the statement to the hardware database.

6. The hardware database of claim 1 wherein the statements are Structured Query Language statements.

7. The hardware database of claim 1 wherein the hardware database further includes a host microprocessor connected to the microprocessor.

8. The hardware database of claim 1 wherein the manipulation of the database by the statements includes reading information from the database, writing information into the database and altering information in the database.

9. The hardware database management system of claim 1 wherein the data flow engine may call routines from the microprocessor.
